(19) United States
(12) Patent Application Publication
(10) Pub. No.: US 2014/0088878 A1
(43) Pub. Date: Mar. 27, 2014

(54) ISOTHERM AND GAS-IN-PLACE ESTIMATION CONSIDERING CAPILLARY CONDENSATION IN SHALE GAS RESERVOIR

(71) Applicants: Jinhong Chen, Katy, TX (US); Guodong Jin, Katy, TX (US); Baoyan Li, Tomball, TX (US); Daniel T. Georgi, Houston, TX (US)

(72) Inventors: Jinhong Chen, Katy, TX (US); Guodong Jin, Katy, TX (US); Baoyan Li, Tomball, TX (US); Daniel T. Georgi, Houston, TX (US)

(21) Appl. No.: 13/628,551

(22) Filed: Sep. 27, 2012

(51) Int. Cl. G06F 19/00

(52) U.S. Cl. 702/13

(57) ABSTRACT

A method for estimating an amount of hydrocarbon in an earth formation having a kerogen includes determining a pore size in the kerogen at or below which capillary condensation will occur, the determining being performed using a processor. The method also includes calculating an amount of hydrocarbon liquid condensate in pores of the kerogen based on capillary condensation using the determined pore size, the calculating being performed using the processor. The method further includes estimating the amount of hydrocarbon in the earth formation using the calculated amount of hydrocarbon liquid condensate, the estimating being performed using the processor.

### BACKGROUND

A model of a shale gas reservoir allows for estimation of gas-in-place, assessment of production potential, forecasting long term production, and planning for production processes among other actions. A conventional shale reservoir model is based on gas of two parts: gas adsorbed on the pore surface of kerogen with density comparable to liquid and free gas in rock pores. These two parts of gas are under dynamic exchange equilibrium under the reservoir pressure and temperature. Traditionally, the adsorbed gas is modeled using a Langmuir adsorption isotherm and the free gas is modeled using the gas state equation. The adsorption isotherm is defined by the Langmuir volume and the Langmuir pressure. Unfortunately, this conventional model may neglect other factors of the shale gas reservoir and lead to inaccurate estimates, assessments, forecasts, and plans based on this model. Hence, it would be appreciated in the hydrocarbon industry if the shale reservoir model could be improved to increase the accuracy of results based on this model.

### BRIEF SUMMARY

Disclosed is a method for estimating an amount of hydrocarbon in an earth formation having a kerogen. The method includes: determining a pore size in the kerogen at or below which capillary condensation will occur, the determining being performed using a processor; calculating an amount of hydrocarbon liquid condensate in pores of the kerogen based on capillary condensation using the determined pore size, the calculating being performed using the processor; and estimating the amount of hydrocarbon in the earth formation using the calculated amount of hydrocarbon liquid condensate, the estimating being performed using the processor.

Also disclosed is an apparatus for estimating an amount of hydrocarbon in an earth formation having a kerogen. The apparatus includes a processor. The processor is configured to: determine a pore size in the kerogen at or below which capillary condensation will occur; calculate an amount of hydrocarbon liquid condensate in pores of the kerogen based on capillary condensation using the determined pore size; and estimate the amount of hydrocarbon in the earth formation using the calculated amount of hydrocarbon liquid condensate.

### BRIEF DESCRIPTION OF THE DRAWINGS

The following descriptions should not be considered limiting in any way. With reference to the accompanying drawings, like elements are numbered alike:

FIG. 1 illustrates an exemplary embodiment of a downhole tool disposed in a borehole penetrating the earth;

FIG. 2 depicts aspects of gas and liquid hydrocarbons disposed in kerogen that is in a rock matrix; and

FIG. 3 is a flow chart for a method for estimating total hydrocarbon-in-place.

### DETAILED DESCRIPTION

A detailed description of one or more embodiments of the disclosed apparatus and method presented herein by way of exemplification and not limitation with reference to the Figures.

Disclosed in an improved model of a shale gas reservoir. The shale gas reservoir model takes into account that hydrocarbons may exist in kerogen pores due to capillary condensation. Using this model, more accurate estimates of hydrocarbons-in-place may be determined.

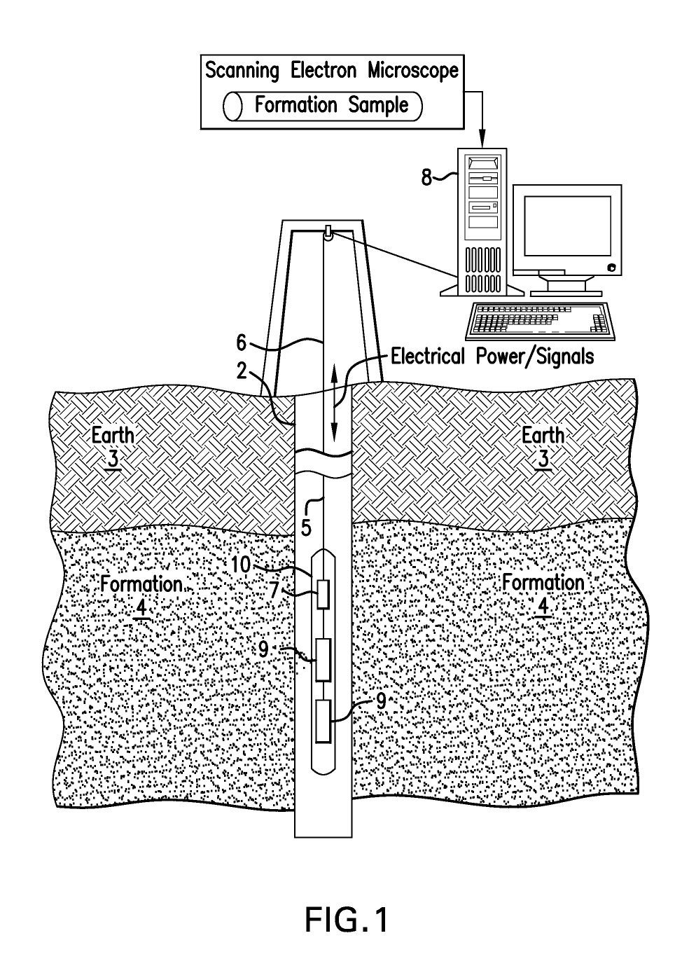

FIG. 1 illustrates a cross-sectional view of an exemplary embodiment of a downhole tool 10 disposed in a borehole 2 penetrating the earth 3, which includes an earth formation 4. The downhole tool 10 is configured to measure properties and/or obtain samples of the formation 4. The measured properties and/or data from samples may be used as data inputs into the shale reservoir model. The downhole tool 10 is conveyed through the borehole 2 by a carrier 5. In the embodiment of FIG. 1, the carrier 4 is an armored wireline 6. Besides supporting the downhole tool 10 in the borehole 2, the wireline 6 can also provide communications between the downhole tool and a computer processing system 8 disposed at the surface of the earth 3. In logging-while-drilling (LWD) or measurement-while-drilling (MWD) embodiments, the carrier 5 can be a drill string or drill tubular. In order to operate the downhole tool 10, process data, and/or provide a communications interface with the surface computer processing system 8, the downhole tool 10 includes downhole electronics 7. Control, processing, or computational functions may be performed by the downhole electronics 7, the surface computer processing system 8 or by a combination thereof.

The downhole tool 10 includes one or more sensors 9 configured to measure one or more properties of the earth formation 4. Non-limiting embodiments of the sensors 9 include a temperature sensor for measuring the temperature of the earth formation 4, a pressure sensor for measuring the fluid pressure of the formation 4, a spectrometer for measuring a chemical composition of the earth formation 4, and a radiation detector for measuring natural or induced radiation from the earth formation. Detection of radiation induced by neutrons emitted from a neutron source (not shown) may be used to determine the porosity and/or the density of the earth formation 4. Various other components may be included in the downhole tool 10. For example, the downhole tool 10 may include a formation tester (not shown) for obtaining a sample of formation fluid and/or measuring formation fluid pressure. The formation tester may be configured to measure a property of the sample or it may contain the sample for later retrieval at the surface. The downhole tool 10 may also include a coring device (not shown) configured to obtain a core sample of the formation 4, which may be analyzed at the surface.

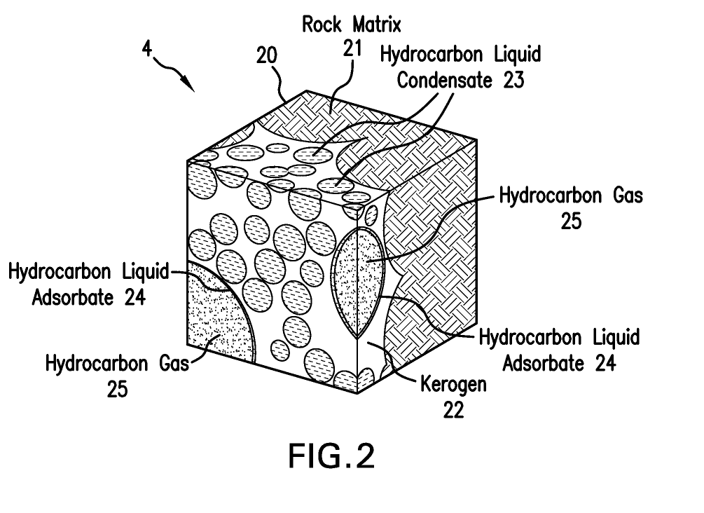

Reference may now be had to FIG. 2 depicting aspects of a section 20 of the formation 4 and hydrocarbons disposed therein. The section 20 includes rock matrix (i.e., inorganic matrix material) 21 and a kerogen (i.e., organic material) 22 disposed in a void in the rock matrix 21. Hydrocarbon condensate 23 (i.e., a liquid condensed from a gas) is disposed in small pores in the kerogen 22 due to capillary condensation. A film or layer of high density hydrocarbon liquid adsorbate 24 is also adsorbed on the surface of large pores in the kerogen 22 where the large pores have a diameter greater than the diameter of the small pores and the small pores are small enough for capillary condensation to occur. In general, the large pores are too large for capillary condensation to occur. Free hydrocarbon gas 25 is also disposed in the large pores that have hydrocarbon liquid adsorbate 24 disposed on them.

In free space, gas condenses to liquid only when the gas vapor pressure Pᵥ is equal to or greater than the saturation pressure Pₛₐₜ. Under favorable conditions in meso-pores, however, capillary condensation may occur and gas may condense into liquid even when the gas pressure is lower than the saturation pressure due to the interaction between the pore surface and the molecules inside the pores. For capillary condensation to occur in a pore with radius r, the Kelvin Equation (Equation 1) must be satisfied:

$${P}_{v} \geq {P}_{sat} exp ( - \frac{2 {σ}_{lg} {V}_{L} cos θ}{r RT} ) \qquad ( 1 )$$

where Pᵥ is the vapor pressure, Pₛₐₜ is the saturation vapor pressure, σ_{lg} is the surface tension between liquid and gas, θ describes the pore surface wettability to the liquid, Vₗ is the liquid molar volume, R (8.31 J/mol·K) is the gas constant, and T is the temperature in degrees Kelvin.

Equation (1) shows that when the gas pressure is smaller than saturation pressure, capillary condensation occurs only when θ is smaller than 90° or the gas wets the pore surface. Therefore, the two conditions for capillary condensation are that the gas wets the pore surface and that the pore size is small enough for Eq. (1) to be true. When these two conditions are satisfied, the pore is filled with liquid.

Equation (1) can be easily converted into Equation (2) below to obtain the pore size for capillary condensation to happen.

$${r}_{cc} = - \frac{2 {σ}_{lg} {V}_{L} cos θ}{RT ln ( {P}_{v} / {P}_{sat} )} \qquad ( 2 )$$

Conditions are generally favorable in the pores in kerogen for capillary condensation to occur. The pore size range in kerogen is from several to a few hundred nanometers. Organic matter (e.g., kerogen) forming the pore surface is non-polar and strongly wets the non-polar hydrocarbon. The pore size in the inorganic matrix is estimated in one or more embodiments to be from nano-meters (nm) to micro-meters (μm). The wettability of these pore surfaces is generally not strongly hydrocarbon wet, or at least not as strongly hydrocarbon wet as the kerogen pores. Consequently, capillary condensation may be difficult to occur in the matrix pores.

To estimate the largest pore size, r_{cc}, for capillary condensation to occur at reservoir pressure Pᵥ and temperature T, the three parameters in Eq. (2) must be known: surface tension σ_{lg}, molar volume V_{L}, and saturation pressure Pₛₐₜ. Hydrocarbon in shale gas reservoir is generally a mixture of compounds with different carbon numbers. These three parameters purely depend on the composition of the hydrocarbon mixture. Two approaches, among others, may be used to obtain these three parameters: laboratory measurement from downhole samples and calculation from established correlation(s) based on the composition.

The pore size distribution in gas shale is generally unknown, however, a good estimate may be obtained from micro-imaging core samples with a scanning electron microscope (SEM). From one or more images, pore sizes and a distribution of the pore sizes may be determined by inspection and/or analysis of the images. Alternatively or in addition to the imaging, logging data obtained using the sensors 9 may be used to determine the distribution of pore sizes using a correlation between one or more sensed properties and a known pore size distribution. The correlation may be known or determined experimentally from rock samples the same as or similar to the rock in the formation 4. A distribution of the pore sizes may be estimated, for example, by a Gaussian distribution or several overlapped or summed Gaussian distributions. The pore size distribution is the last piece needed to estimate the hydrocarbon-in-place and the adsorbate isotherm in a shale gas play, which includes three parts: (1) liquid hydrocarbon from capillary condensation; (2) adsorbed hydrocarbon on the pore surface for the kerogen pores with size large enough that capillary condensation is not formed; and (3) free gas in large pores.

An exemplary calculation is now performed to calculate the total hydrocarbon mass at reservoir conditions and then convert the result to the total gas at ground or surface conditions.

1. Liquid Hydrocarbon from Capillary Condensation.

Pores with size smaller than r_{cc} hold liquid. Pores with size larger r_{cc} have adsorbate on the pores walls while free gas is in the remaining pore space. The total volume hydrocarbon liquid, V_{ccl}, from capillary condensation is then obtained using Equation (3):

$${V}_{ccl} = {C}_{V} {\int }_{0}^{{r}_{cc}} π {r}^{2} P ( r ) d r \qquad ( 3 )$$

where P(r) is the normalized distribution of the pore size as a function of pore radius and C_{V} is a constant. The total mass amount of hydrocarbon of fluid, m_{ccl}, is then Equation (4) below.

m_{ccl}=ρV_{ccl} (4)

Here, ρ is the liquid density at reservoir conditions.

2. Surface Adsorption.

Adsorbate is physically adsorbed on the pore wall. Here, only those pores with size larger than r_{cc} are accounted for. The total surface area of these large pores, A_{ads}(r), can be calculated from Equation (5):

$${A}_{ads} ( r ) = {C}_{A} {\int }_{{r}_{cc}}^{∞} 2 π r \cdot P ( r ) d r \qquad ( 5 )$$

where C_{A} is a constant.

The fraction of surface that is filled with adsorbate is given by the Langmuir model in Equation (6).

$$f = \frac{α \cdot {P}_{v}}{1 + α \cdot {P}_{v}} \qquad ( 6 )$$

where f is the fraction of pore surface that is filled with adsorbate and α is the Langmuir adsorption constant. The mass of the adsorbate can also be determined using the liquid density as shown in Equation (7).

m_{ads}=A_{ads}·f·t·ρ (7)

where t is the thickness of the molecule layer. In this calculation, a Langmuir model was used. In one or more embodiments, the Langmuir model may be replaced with a more complicated model to account for the case where more than one layer of molecules may be adsorbed on the pore wall.

3. Free Gas Inside Large Pores.

The inner space of the large pores is filled with free gas. The total volume occupied by free gas is the subtraction of the surface adsorbate volume from the pore volume as in Equation (8):

$${V}_{gas} = {C}_{g} {\int }_{{r}_{cc}}^{∞} π {r}^{2} \cdot P ( r ) d r - {A}_{ads} t \qquad ( 8 )$$

where C_{g} is a constant.

The total mole number n of gas can then be derived from the Van der Waals equation for non-ideal gas as in Equation (9).

$$( p + \frac{{an}^{2}}{{V}_{gas}^{2}} ) ( {V}_{gas} - nb ) = nRT \qquad ( 9 )$$

where a and b are constants depending on the gas and on the composition of the hydrocarbon mixture. The total mass of gas is determined using Equation (10).

m_{gas}=n·M (10)

where M is the average molar mass of the hydrocarbon.

The total mass of the hydrocarbon is the summation of the liquid from capillary condensation, the adsorbate on the surface of large pores, and gas within the large pores as in Equation (11).

m=m_{ccl}+m_{ads}+m_{gas} (11)

The total mass may be converted to the corresponding gas volume at the ground or surface condition (e.g., 20° C. and 1 atm. pressure) as in Equation (12).

$$V = \frac{m}{M} \times 22.4 / 1 , 000 ( {m}^{3} ) \qquad ( 12 )$$

In one or more embodiments, the pore size distribution is modeled as a Gaussian distribution as in Equation (13).

$$P ( r ) = \frac{1}{\sqrt{2 πδ}} exp [ - \frac{{( r - {r}_{m} )}^{2}}{2 {δ}^{2}} ] \qquad ( 13 )$$

where rₘ is the mean of pore size at which that pore size has the largest probability and δ determines the width of the Gaussian distribution.

Using the Gaussian distribution for pore size distribution, Equations (3), (5), and (8) can be integrated resulting in Equations (14), (15), and (16), respectively.

$$\begin{matrix}{V}_{ccl} = \begin{matrix}\frac{π l {C}_{V}}{\sqrt{2 πδ}} \frac{δ}{2} exp ( - \frac{{r}_{m}^{2} + {r}^{2}}{2 {δ}^{2}} ) [ \sqrt{2 π} ( {r}_{m}^{2} + {δ}^{2} ) exp ( \frac{{r}_{m}^{2} + {r}^{2}}{2 {δ}^{2}} ) erf \\ {( \frac{r - {r}_{m}}{\sqrt{2} δ} ) - 2 δ ( r + {r}_{m} ) exp ( \frac{{r}_{m} r}{{δ}^{2}} ) ] \vert}_{0}^{{r}_{cc}}\end{matrix} & ( 14 ) \\ {{A}_{ads} = \frac{2 π l {C}_{A}}{\sqrt{2 πδ}} \{ - {δ}^{2} exp [ - \frac{{( r - {r}_{m} )}^{2}}{2 {δ}^{2}} ] - \sqrt{\frac{π}{2}} δ {r}_{m} erf ( - \frac{r - {r}_{m}}{\sqrt{2 δ}} ) \} \vert}_{{r}_{cc}}^{∞} & ( 15 ) \\ {V}_{gas} = \begin{matrix}{C}_{g} \frac{π l}{\sqrt{2 πδ}} \frac{δ}{2} exp ( - \frac{{r}_{m}^{2} + {r}^{2}}{2 {δ}^{2}} ) [ \sqrt{2 π} ( {r}_{m}^{2} + {δ}^{2} ) exp ( \frac{{r}_{m}^{2} + {r}^{2}}{2 {δ}^{2}} ) erf \\ {( \frac{r - {r}_{m}}{\sqrt{2} δ} ) - 2 δ ( r + {r}_{m} ) exp ( \frac{{r}_{m} r}{{δ}^{2}} ) ] \vert}_{{r}_{cc}}^{∞} - {A}_{ads} t\end{matrix} & ( 16 )\end{matrix}$$

In Equations (14), (15), and (16), erf refers to an error function (also called Gauss error function).

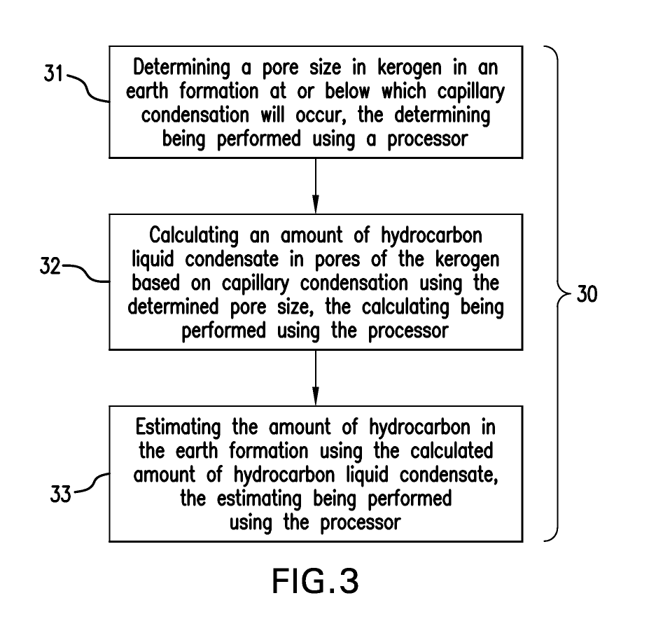

FIG. 3 is a flow chart for a method 30 for estimating an amount of hydrocarbon in an earth formation having a kerogen. Block 31 calls for determining a pore size in the kerogen at or below which capillary condensation will occur using a processor. Block 32 calls for calculating an amount of hydrocarbon liquid condensate in pores of the kerogen based on capillary condensation using the determined pore size, the calculating being performed using the processor. Block 32 can also call for receiving a distribution of pore sizes in the kerogen and using the pore size distribution for calculating the amount of hydrocarbon liquid condensate. Block 33 calls for estimating the amount of hydrocarbon in the earth formation using the calculated amount of hydrocarbon liquid condensate, the estimating being performed using the processor. Block 33 can also call for calculating an amount of hydrocarbon gas in the kerogen using a distribution of pore sizes of the kerogen and estimating the amount of hydrocarbon further using the calculated amount of hydrocarbon gas. Block 33 can also call for calculating an amount of hydrocarbon liquid adsorbate based on adsorption of hydrocarbon liquid in pores containing hydrocarbon gas using the distribution of pore sizes of the kerogen and estimating the amount of hydrocarbon further using the calculated amount of hydrocarbon liquid adsorbate.

In support of the teachings herein, various analysis components may be used, including a digital and/or an analog system. For example, the downhole electronics 7, the surface computer processing 8, or the sensors 9 may include the digital and/or analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “carrier” as used herein means any device, device component, combination of devices, media and/or member that may be used to convey, house, support or otherwise facilitate the use of another device, device component, combination of devices, media and/or member. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for estimating an amount of hydrocarbon in an earth formation having a kerogen, the method comprising:
determining a pore size in the kerogen at or below which capillary condensation will occur, the determining being performed using a processor;
calculating an amount of hydrocarbon liquid condensate in pores of the kerogen based on capillary condensation using the determined pore size, the calculating being performed using the processor; and
estimating the amount of hydrocarbon in the earth formation using the calculated amount of hydrocarbon liquid condensate, the estimating being performed using the processor.

2. The method according to claim 1, further comprising receiving a distribution of pore sizes in the kerogen and using the distribution to calculate the amount of hydrocarbon liquid condensate.

3. The method according to claim 2, further comprising imaging a sample of the earth formation with a scanning electron microscope to determine the distribution of pore sizes of the kerogen.

4. The method according to claim 2, further comprising sensing a property of the earth formation related to the pore size distribution using a sensor.

5. The method according to claim 2, further comprising calculating an amount of hydrocarbon gas in the kerogen using the distribution of pore sizes of the kerogen and estimating the amount of hydrocarbon further using the calculated amount of hydrocarbon gas.

6. The method according to claim 5, further comprising calculating an amount of hydrocarbon liquid adsorbate based on adsorption of hydrocarbon liquid in pores containing hydrocarbon gas using the distribution of pore sizes of the kerogen and estimating the amount of hydrocarbon further using the calculated amount of hydrocarbon liquid adsorbate.

7. The method according to claim 6, further comprising summing the amount of hydrocarbon liquid condensate, the amount of hydrocarbon gas, and the amount of hydrocarbon liquid adsorbate to estimate the amount of hydrocarbon in the earth formation.

8. The method according to claim 1, wherein the pore size in the kerogen at or below which capillary condensation will occur is determined by solving:
$${r}_{cc} = - \frac{2 {σ}_{lg} {V}_{L} cos θ}{RT ln ( {P}_{v} / {P}_{sat} )}$$
where Pᵥ is the vapor pressure, Pₛₐₜ is the saturation vapor pressure, σ_{lg} is the surface tension between liquid and gas, θ describes the pore surface wettability to the liquid, Vₗ is the liquid molar volume, R (8.31 J/mol·K) is the gas constant, and T is the temperature in degrees Kelvin.

9. The method according to claim 8, further comprising calculating a volume of the hydrocarbon liquid condensate by solving:
$${V}_{ccl} = {C}_{V} {\int }_{0}^{{r}_{cc}} π {r}^{2} P ( r ) d r$$
where P(r) is a normalized distribution of the pore size as a function of pore radius and Cᵥ is a constant.

10. The method according to claim 9, wherein P(r) is modeled as a Gaussian function or a sum of Gaussian functions.

11. An apparatus for estimating an amount of hydrocarbon in an earth formation having a kerogen, the apparatus comprising:
a processor configured to:
determine a pore size in the kerogen at or below which capillary condensation will occur;
calculate an amount of hydrocarbon liquid condensate in pores of the kerogen based on capillary condensation using the determined pore size; and
estimate the amount of hydrocarbon in the earth formation using the calculated amount of hydrocarbon liquid condensate.

12. The apparatus according to claim 11, wherein the processor is further configured to receive a distribution of pore sizes in the kerogen, the distribution of pore sizes being used to calculate the amount of hydrocarbon liquid condensate.

13. The apparatus according to claim 12, further comprising a sensor configured to sense a property of the earth formation related to the distribution of pore sizes.

14. The apparatus according to claim 12, wherein the processor is further configured to calculate an amount of hydrocarbon gas in the kerogen using the distribution of pore sizes in the kerogen and to estimate the amount of hydrocarbon further using the calculated amount of hydrocarbon gas.

15. The apparatus according to claim 14, wherein the processor is further configured to calculate an amount of hydrocarbon liquid adsorbate based on adsorption of hydrocarbon liquid in pores containing hydrocarbon gas using the distribution of pore sizes in the kerogen and to estimate the amount of hydrocarbon further using the calculated amount of hydrocarbon liquid adsorbate.

16. The apparatus according to claim 15, wherein the processor is further configured to estimate the amount of hydrocarbon in the earth formation by summing the amount of hydrocarbon liquid condensate, the amount of hydrocarbon gas, and the amount of hydrocarbon liquid adsorbate.
